(19) United States
(12) Patent Application Publication
(10) Pub. No.: US 2004/0192378 A1
(43) Pub. Date: Sep. 30, 2004

(54) Wireless switchboard system

(75) Inventor: Itzhak Wulkan, Ranana (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 10/395,196

(22) Filed: Mar. 25, 2003

(51) Int. Cl. H04L 12/28; H04M 1/00; H04Q 7/20

(52) U.S. Cl. 455/555; 455/554.1; 455/445; 370/401

(57) ABSTRACT

A remote telephone system for wireless telephony devices includes a remote server having communication control support to provide digital communication function control. Wireless telephony devices are grouped and the support is independently programmable for each group. The remote server further includes a data port connected to the communication control support for supporting a wireless data link to an individual wireless telephony device, and the remote server uses the data port to exchange programmed digital communication function control with the individual device. The data link to the control support gives the wireless device the functionality of a smart handset and bestows upon the group properties of an office exchange.

### BACKGROUND OF THE INVENTION

1. Field of the Invention

The present invention relates to a wireless telephone system able to support provision of smart terminals over wireless links and more particularly, but not exclusively, to wireless smart end units for remotely located office type telephone systems.

2. Description of the Related Art

Businesses tend to have multiple telephones and thus use internal office based telephone systems or exchanges rather than connecting directly to the public network. The internal telephone system generally connects all of the business's telephones together, providing full intra-office servicing. The internal office-based exchange also serves to link the multiple telephones to the outside world via a trunk connection. The best-known office-based telephone system is the PBX or private branch exchange.

Over the years PBX has been augmented to allow for the use of smart handsets. Smart handsets give the user advanced features to make telephone usage more friendly, and allow the user to program certain types of PBX functionality, or monitor PBX usage. PBXs are hardware (HW) systems that require capital expenditure. Additionally, smart handsets have to be connected to the PBX via both a voice and a data connection. Voice is usually implemented via two lines and data is generally implemented via two further lines so that the smart handset requires a 4-wire connection. That is, in addition to the two wires for voice required by any handset, a smart handset also requires two additional wires for data communication. The data wires allow for central setting or programming operations to be carried out between the smart handset and the PBX, and also for use involving operation or control of functions of the smart handset. It will be appreciated that the handsets themselves are more expensive than regular telephones. Thus, the end user price for a PBX, with smart handsets may be relatively high. The ability to support smart handsets is a particular benefit of using a PBX, and an additional benefit is that calls within the office are free.

Despite the equipment and setup costs, PBX penetration has been quite widespread, with resulting loss to telephone operators of revenues due to intra-office calls. Thus, to compete with the PBX, operators have developed a software product called Centrex.

Centrex, an acronym for central office exchange service, is a service that allows local telephone operators to emulate office telephone system functionality. Up-to-date telephone facilities at the local telephone company's central or local office are offered to business users instead of requiring them to purchase their own facilities. The Centrex service effectively partitions part of the central switching capabilities among the business customers to provide each customer with his own virtual exchange. A major benefit to the customer is that he is spared the expense of having to keep up with fast-moving technology changes. For example, the customer does not have to continually update his private branch exchange infrastructure. In addition, the telephone provider gains a new set of services to sell.

In many ways, Centrex replaces the customer end private branch exchange. Effectively, the central office becomes a branch exchange for all of its local customers. In most cases, Centrex, which is offered under different names in different localities, provides customers with as much if not more control over the services than PBX is able to.

In certain cases, the telephone company places at least some of the Centrex equipment on the customer premises, so that location at the telephone company exchange is not definitive for Centrex technology.

Centrex emulates some of the PBX functionality but does require communication with the local exchange (C/O—Central Office). PBX functions that Centrex emulates include features such as short dialing, voice mail indicator, extensions status, and short number dialing, meaning allowing customer defined 3-4 digit numbers rather than the full 7-10 digit number. Centrex eliminates the need for capital expenditure as it is implemented as a software package at the central office.

However, Centrex suffers from a significant disadvantage over PBX, namely Centrex lacks the ability to support smart handsets. Centrex relies upon a regular telephone line to connect to the user and thus lacks the separate data communication capabilities, that is the four-wire connection, which is the basis for smart handset functionality. Lack of smart handset functionality has therefore formed a barrier for Centrex penetration. Currently it is not possible to use the two wire pair of the standard “last mile” telephone connection to support smart handsets. Thus, programming and use of special functions is difficult to support.

### SUMMARY OF THE INVENTION

Illustrative, non-limiting embodiments of the present invention provide smart end unit support for telephone company based office type virtual telephone systems, which support includes support for smart units. The illustrative, non-limiting embodiments also provide mobile or cellular end units with smart handset functionality, and a software user client for downloading to cellular end units to support smart handset functionality. The data communication needed for smart handset functionality is provided via the data connection available with cellular telephony connections. Thus, the user is provided with the benefit of no capital setup cost, or no significant cost, and yet is able to use smart handsets.

According to a first illustrative, non-limiting aspect of the present invention there is thus provided a remote telephone system for wireless telephony devices. The system comprises: a remote server comprising communication control support to provide digital communication function control groupwise programmable for respective wireless telephony devices, and a data port operatively connected to the communication control support for supporting wireless data links to respective wireless telephony devices, such that the wireless data link is usable by the remote server to exchange the digital communication function control with a respective wireless telephony device of the group.

According to a second illustrative, non-limiting aspect of the present invention there is provided wireless voice communication end unit comprising: wireless voice communication functionality, wireless data communication functionality, and a software client for operatively associating the wireless data communication functionality with the wireless voice communication functionality, thereby to apply remotely supported communication control features supplied from a remote communication control unit via the data communication functionality to the end unit.

According to a third illustrative, non-limiting aspect of the present invention there is provided a wireless end unit smart terminal client for a wireless end unit having voice communication functionality for setting up and maintaining a voice communication channel, and data communication functionality for setting up and maintaining a data communication channel, the client comprising a co-ordinator for operatively associating the voice communication functionality and the data communication functionality to utilize received data to control the voice communication functionality.

According to a fourth illustrative, non-limiting aspect of the present invention there is provided a method of remotely providing smart handset functionality comprising: setting up a telephone system support unit at a mobile switching center location, downloading a smart handset client to wireless end units, the smart handset client being operable to manage a voice communication channel and a data communication channel to the telephone system support unit, and defining groups of wireless end units for joint switching.

According to a fifth illustrative, non-limiting aspect of the present invention there is provided a method of remotely providing smart switching functionality to a wireless end unit, the method comprising: setting up a wireless voice connection channel, setting up a wireless data connection channel in operative association with the wireless voice connection channel and directed at a remotely located common switching unit, and using the wireless data channel to convey smart switching functionality data between the wireless end unit and the remotely located common switching unit.

### BRIEF DESCRIPTION OF THE DRAWINGS

Aspects of illustrative, non-limiting embodiments of the present invention will become more apparent by describing in detail embodiments thereof with reference to the attached drawings. With specific reference to the drawings, it is stressed that the particulars shown are by way of example and for purposes of illustrative discussion of the embodiments of the present invention only. Structural details of the invention are not shown in more detail than is necessary for a fundamental understanding of the invention, the description taken with the drawings making apparent to those skilled in the art how the several forms of the invention may be embodied in practice. In the accompanying drawings:

FIG. 1 is a simplified diagram showing a centralized telephone system for the mobile telephony environment, according to a first illustrative, non-limiting embodiment of the present invention,

FIG. 2 is a simplified block diagram of a wireless end unit for use with the embodiment of FIG. 1,

FIG. 3 is a simplified block diagram showing the user client of FIG. 2,

FIG. 4 is a simplified block diagram showing a Centrex software module at the mobile switching center of FIG. 1,

FIG. 5 is a simplified flow chart showing a configuration procedure for setting up a telephone system group according to an illustrative, non-limiting embodiment of the present invention, and

FIG. 6 is a simplified flow chart showing a call setup procedure for setting up a mobile telephone call using Centrex control according to an illustrative, non-limiting embodiment of the present invention.

### DESCRIPTION OF ILLUSTRATIVE NON LIMITING EMBODIMENTS OF THE INVENTION

The following description of illustrative non-limiting embodiments of the invention discloses specific configurations, features, and operations. However, the embodiments are merely examples of the present invention, and thus, the specific features described below are merely used to more easily describe such embodiments and to provide an overall understanding of the present invention.

Accordingly, one skilled in the art will readily recognize that the present invention is not limited to the specific embodiments described below. Furthermore, the description of various configurations, features, and operations of the present invention that are known to one skilled in the art are omitted for the sake of clarity and brevity. Also, it is to be understood that the phraseology and terminology employed herein is for the purpose of description and should not be regarded as limiting.

The present illustrative, non-limiting embodiments provide a system that takes advantage of the data channel that is now available in mobile telephony systems to replace the four wire connections of the office telephone system, and thereby permit smart handsets over the mobile network. Client software for mobile end units allows use of the data channel to contact a central server on top of regular use of the voice channel. Enhanced display, if present, is used to provide a user-friendly interface at the mobile end unit.

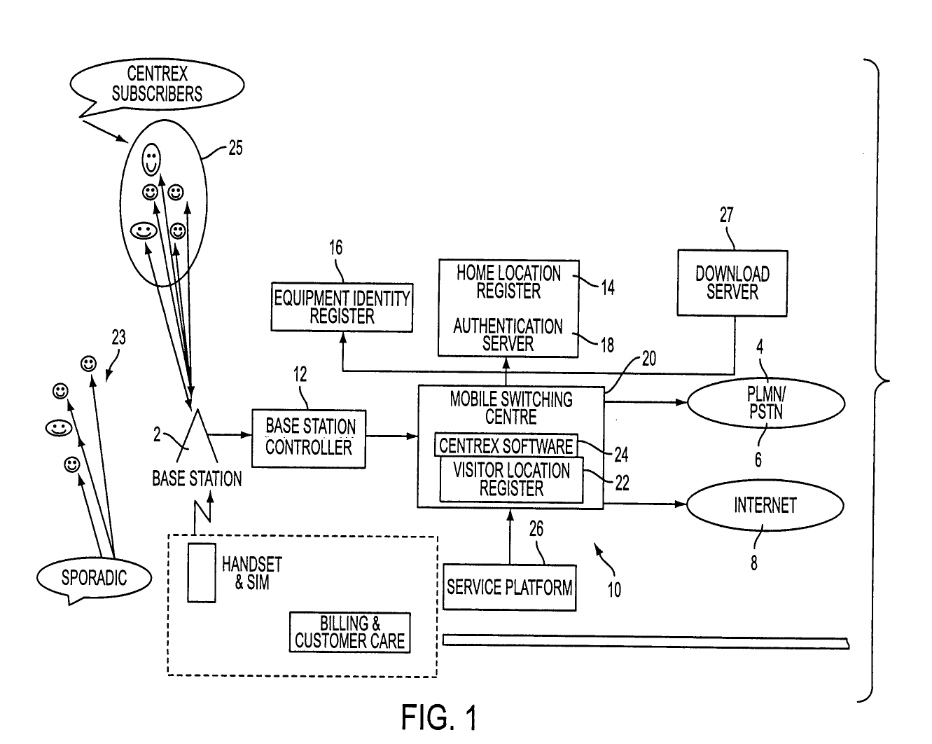

Reference is now made to FIG. 1, which is a simplified block diagram of a mobile telephone communication system including a base station and subscribers linked by telephone system support according to a first illustrative, non-limiting embodiment of the present invention. A cellular base station 2 links mobile subscribers to the Public Land Mobile Network (PLMN) 4 or the Public Switched Telephone Network (PSTN) 6 which are also connected to the Internet 8. A cellular base station for the mobile network comprises a base station controller 12 and, in addition, the cellular network includes network shared facilities such as a home location register (HLR) 14, and an equipment identity register (EIR) 16. The base station 2 may further include an authentication center 18, a mobile switching center (MSC) 20, and a visitor location register (VLR) 22. Both voice and digital facilities are thus available on the same mobile telephone units but operate separately to provide different services. Generally users 23 are sporadically connected to the base station.

In addition, the mobile switching center 20 according to the present illustrative, non-limiting embodiment further comprises telephone system software. The software may be what is known as Centrex software 24, which allows for mobile users to be grouped together to form group 25, and which supports standard telephone system functions amongst that group. The telephone system software may be provided as part of a service platform 26 on which the mobile switching center as a whole is mounted or may be incorporated in a separate server. A download server 27 is connected to the link between the authentication center 18, the mobile switching center 20, and the equipment identity register 16. Its function is discussed hereinbelow. In an illustrative, non-limiting embodiment, the telephone system software incorporates standard Centrex software as part of the telephone system software 24 for telephone exchange based facilities.

The telephone system software operates in substantially the same way as a standard office PBX, providing substantially the same range of services to a predefined group of mobile end units. However, the software uses the voice lines and the cellular data lines together for communication. The wireless voice channels are treated in the same way as the two voice lines, and the mobile data channels are treated in the same way as the two data lines in the four-line PBX—handset connections so that smart handset control can be provided in the same way as with office-based PBX. A software client is installed in the individual handsets to enable them to make use of the data channels to provide smart handset capability, and thus any cellular handset is able to operate within its group as a smart handset and use all of the features currently only available to office-based smart handsets installed in conjunction with built-in PBX systems.

The Centrex software 24, may be installed on a remote server functioning as the service platform 26 or the service platform 26 may be implemented as part of the MSC 20. In either case the Centrex software includes communication control support for the defined group of mobile telephones, which is able to use the cellular data connection to provide control and programming. The software is configured to provide digital communication function control at the level of the group, at the level of subgroups within the group and at the level of individual mobile end-units. Digital communication function control includes such features as abbreviated dialing, pick up groups, setting and execution of default attendant function etc. Certain exchange functions are typically configured at a group level, some at a sub-group level and some are typically defined by or for individual users. All such levels are preferably supported by the remote telephone system software.

The Centrex software utilizes a data port It is noted that the data ports 28 is the equivalent of the four wire connection in a wireline office exchange system. In wireless communication, the data port may be an IP data communication link for GPRS, CDMA/IS95, CDMA 1XRTT, iDen, UMTS and others for supporting wireless data links to the mobile end units.

The Centrex software is designed to be configured from the wireless end units themselves. Thus, individual users may use the keypads of their end units to program their own configurations as in a standard office telephone system. Certain of the wireless end units may be provided with group programming permission levels to program the overall group configuration or a configuration for a subgroup. In addition or as an alternative, programming can be accomplished via a terminal connected either to the MSC or to the services platform 26. Thus, the telephone system software unit preferably defines if and when it accepts group programming input for configuration data from the end units, and defines what configuration data it accepts from the units themselves in order to carry out such configuration. Following initial programming or initial defaults, further definitions can be made either centrally by a technician who programs the system or by a user, who uses the keypad to tap in commands.

The telephone system software preferably provides wireless end units with functions including:

short number dialing,

status monitoring of other wireless end units in the group,

selection of a telephone number from a displayed list,

selection of a telephone number from a displayed list of names,

call forward,

visual activation of call forward,

visual deactivation of call forward,

visual display of call forward activation,

call follow me,

visual activation of call follow me,

visual deactivation of call follow me,

visual display of call follow me activation,

call pickup,

hot line,

telephone conferencing,

number redial,

internal CLI (Caller Line Identification)-namely display of extension number rather than display of telephone number

CCBS—Call Completion on Busy subscriber, referred to as “Camp On”

visual voicemail notification,

display of waiting voicemails, PIN (Personal Identification Number) based telephone locking, and

setting of conference calls.

In addition, programming functions may be provided so that selected master telephones can provide configuration commands for the group, such as adding a new telephone or assigning an extension number, or assigning a restricted function to a given telephone and the like.

It will be observed that some of the above functions are standard telephone system functions provided by many conventional telephone system configurations. Other functions are modified for the wireless environment, as will be described in greater detail below.

Thus, in accordance with the above, a wireless end unit, such as a smart handset or a regular mobile telephone and grouped through a telephone system with other end units, is able to supply premium services as compared to ungrouped end units. Such premium services may be selected by consideration of the user's business environment, and those premium functions which it is possible to implement on smart handsets, and which are not possible on dumb handsets.

A brief explanation of some of the currently available premium functions is as follows:

Mnemonic dialing. Different names are presented on the screen, which may conveniently be larger than a regular wireless end unit screen. Each name is associated with a fast dialing code (1-N). In order to dial, the user either positions the cursor on the name (if the handset allows for direct cursor manipulation), or the user selects or enters an associated fast dialing number.

Voicemail handling. The user receives a visual notification regarding the number of waiting voicemail messages, if the associated voicemail system supports such notification. If the voicemail system so allows, then the handset initiates a data communication session with the voicemail system in which all voicemail message details are presented on the handset screen. The subscriber may fetch selected voicemail messages in a random manner, by positioning the cursor on the requested voicemail message.

Define a group. Amongst the programming functions that may be provided is that of defining a group. The user obtains a screen on which he may define a group. The groups may typically be used for:

Departmental organization

Night time/weekend attendant

group pickup, and

Sequential call forwarding on no-answer (Pseudo ACD).

Pickup activation, whenever a group pickup is defined, that is to say when a wireless end unit within a group does not answer a call, a symbol appears on the screens of other group users. The pickup may then be activated by clicking the symbol. Optionally, the pickup symbol may be accompanied by an audible notification.

Call forwarding. Activation of call forwarding is provided by clicking a call forwarding symbol. Clicking the symbol may cause a screen to pop up with a destination to be filled. Such a user interface for call forwarding is easier and more intuitive than dialing long number sequences. Activation of forwarding preferably causes display of an icon indicating “forwarding activated”.

Periodic dialing. A periodic dialing icon is made available on screen, to generate periodic dialing to a current destination, until an answer is received. The feature may be used in cases of no answer or busy responses received on an initial dialing attempt. Such a negative result causes the icon to appear automatically.

The telephone system software provides control information in such a way as to be compatible with display facilities on the wireless end units so that control information can be displayed in a useful manner.

The telephone system software includes a group definition unit to define groups of wireless end units for the purposes of telephone system functionality.

The skilled person will appreciate that while FIG. 1 describes the mobile telephony or cellular environment, a Centrex virtual telephone system able to support smart handset functionality is additionally applicable over a wireless local loop that includes a data channel together with a voice channel.

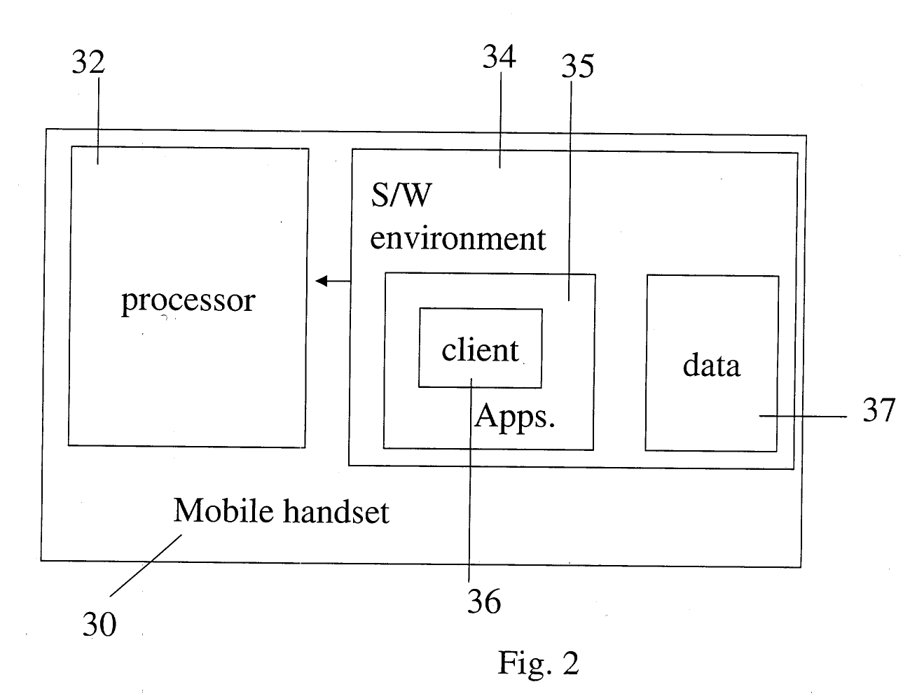

Reference is now made to FIG. 2, which is a simplified diagram of a mobile end unit 30. Mobile end unit 30 comprises a main processor 32, and a software environment 34, which comprises an application region 35 that carries a Centrex client 36. The software environment also includes a data region 37. In an illustrative, non-limiting embodiment, the software environment 34 may be the binary runtime environment for wireless environment known as BREW. Alternative software environments are WIPI, Java, or Symbian (http://www.symbian.com) or any other suitable software environment. The software environment is able to support software smart handset client 36 whose task is to support operation of the end unit as a smart handset. More specifically, the client's task is to recognize incoming data that defines smart handset functionality and generate corresponding activity, and to generate data regarding smart handset functions for sending to the virtual telephone system.

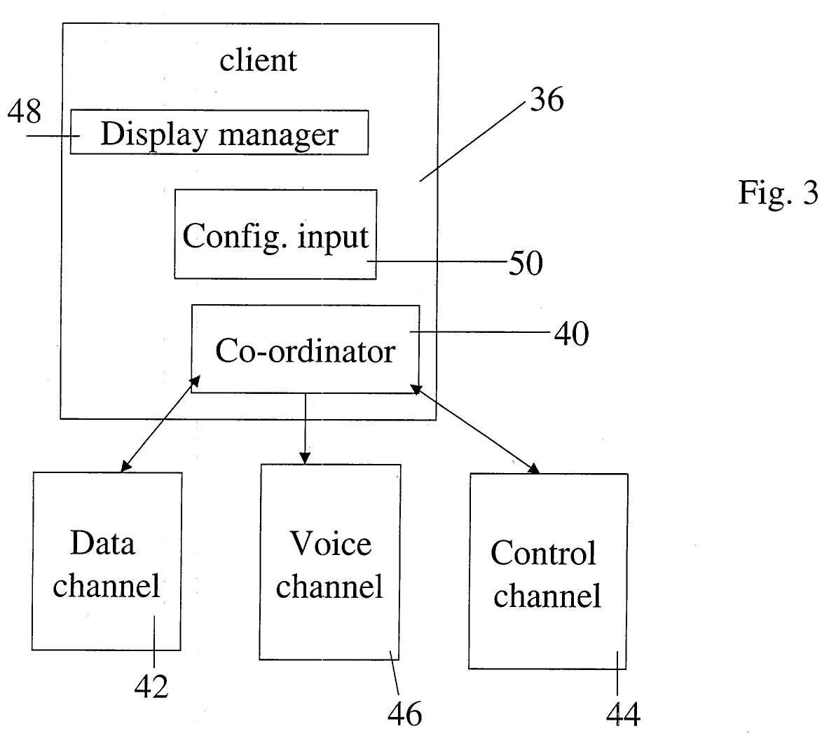

Reference is now made to FIG. 3, which is a simplified diagram showing in greater detail the smart handset client of FIG. 2. The software smart handset user client 36 comprises a co-ordinator 40, which manages the telephone's data 42, control 44 and voice 46 channels. Using the coordinator 40, data received on the data or control channel can be used to operate the cellular telephone as necessary to carry out the various telephone system functions outlined above. Some of the functions are, by definition, carried out in association with the voice channel 46. Other functions require displaying data on the screen or transferring manually entered data to the telephone system. Programming information from the cellular telephone to the telephone system software 24 may be sent using DTMF over the voice channel 46 or may be encoded as data and sent over the data channel 42 or may be sent using the control channel 44.

The user client 36 includes display manager 48 to provide a user interface through the screen associated with the mobile telephone. The user interface comprises an arrangement of menus leading to screens for the various functions. The screens may allow entry of parameters for the function or provide a choice of such parameters for the user to select from as appropriate for the function. The screens also allow the respective function to be carried out.

The arrangement of screens may include configuration screens, thus providing a configuration data input 50 for receiving configuration data from the user. One or more users in each group may be given a level of authority to carry out configuration operations relating to the respective group. The configuration data input recognizes which data is configuration data from the screen context.

A wireless end unit, such as a cellular telephone, has the capacity to support the user client described in respect of FIG. 3, and is also able to download programs and data. Such a wireless end unit preferably has enhanced display capability vis a vis a standard cellular telephone, particularly if it is intended to support configuration, in which case a detailed user interface screen is advantageous.

Returning now to FIG. 1, the wireless network includes a download server 27, which serves to download software applications to the client 36. The client 36 may be downloaded to the smart handset in the same way. For example, such download activity may be carried out using content delivery software for mobile telephony such as “download fun” by Openwave, Inc. of Redwood City, Calif. Thus, any cellular telephone that has the appropriate software environment and the hardware capacity to run a downloadable application of the kind discussed herein can be set up as a smart handset and added to a telephone system group. Consequently, groups for use with the Centrex telephone system may be dynamically defined. For example, a new employee can have his existing mobile end unit programmed and added to the telephone system group as soon as he arrives.

The use of Centrex virtual telephone systems to provide terminal grouping and smart terminal functionality can generate a large amount of configuration data to maintain the virtual telephone systems. The configuration data is stored at the mobile switching center 20. As an alternative, at least some of the configuration data may be stored by the user clients at the cellular telephones or other cellular end units. In the case of the latter alternative the cellular end units effectively become stand-alone smart units, since they are not dependent on any given mobile center for their configuration information.

Although the above has been described in terms of groups of several end units, it is equally possible to define a single mobile end unit as an independent group. In such a case, certain of the above-mentioned functions such as call pickup cease to be relevant but other functions such as programmable short codes are still of interest.

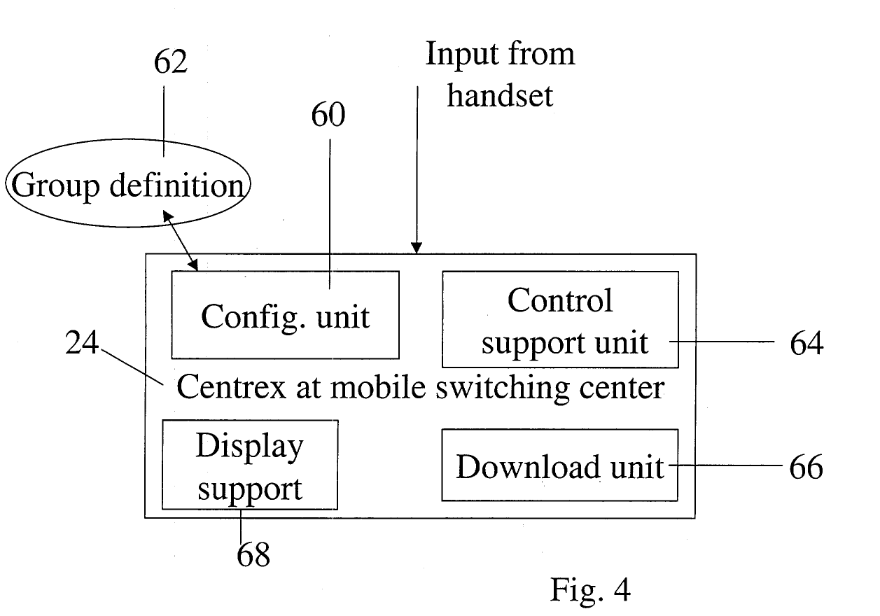

Reference is now made to FIG. 4, which shows in greater detail the Centrex software 24 of FIG. 1. In FIG. 4, the Centrex software module 24, which is located at the mobile switching center, comprises a configuration unit 60 for allowing groups of mobile telephones to be configured together and for storing group definitions 62, including subgroup definitions, and any other configuration data that may be relevant. A typical data set is the kind of data set currently used by Centrex to manage telephone system activity, and which is familiar to the person skilled in the art. A control support unit 64 provides office type functional support for telephony, that is to say the support unit 64 provides a range of functions typically found in office type telephone systems. The functions are available to the telephones according to the particular telephone's arrangement as a member of a group, as defined by configuration unit 60. That is to say, the telephones have been grouped together as if belonging to a respective office telephone system. In effect, Centrex provides a virtual office telephone system. Each telephone system is set up with its own predetermined range of functions, typically including a standard range, that is of common features, together with certain customized value added functions. The telephones in the group then have short dial or extension numbers to allow easy access to other telephones in the group and assorted other functions that are defined for each group. The present embodiments provide added value in that the control support unit 64 is able to include functions that require control data to be communicated between the virtual telephone system and an individual telephone when the individual telephone is a cellular telephone, thus enabling the individual cellular telephone to act as a smart handset, as described above.

A download unit 66 allows appropriate client software to be downloaded to cellular telephones. Basic client software may be downloaded whenever a cellular telephone is added to a virtual telephone system in general. It may be necessary when a given user moves from one company to another company, and thus from one virtual telephone system to another, and it may be necessary as new functions are added to a given telephone system.

Generally the type of screen display for programming a telephone system, that is displaying the function control, is designed for a full size screen. A display support unit 68 preferably reconfigures the function control to be displayed conveniently on the kind of display screen typical to a mobile unit, so that the function control can be used from the mobile unit. Display support may involve downloading display screens for configuring specific functions to cellular telephones and menu systems for reaching the screens. Thus, the menu system may replace the programmable buttons of the conventional smart handset. The display support may involve creating or modifying the user client software that is downloaded to the users by the download unit 66.

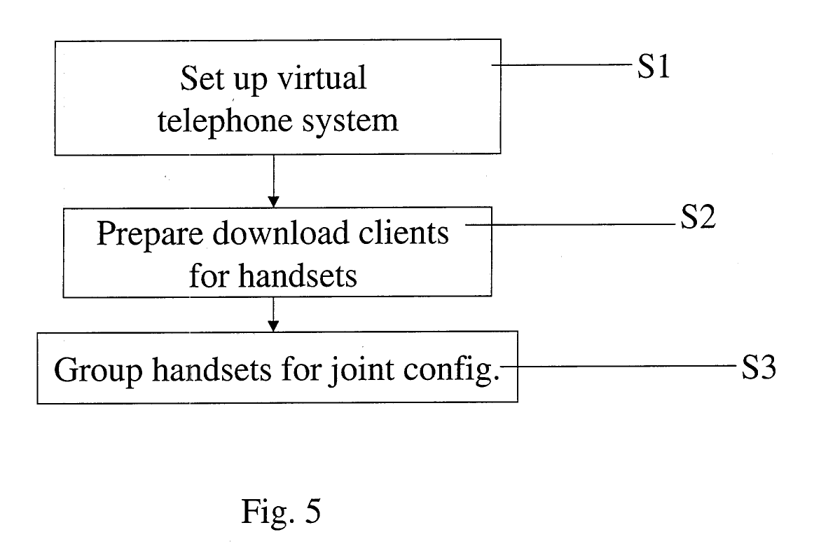

Reference is now made to FIG. 5, which is a simplified flow chart illustrating the process of setting up a virtual office telephone system able to support smart handset functionality over a cellular telephone network, operative in accordance with an illustrative, non-limiting embodiment of the present invention. In a first stage S1, a virtual office telephone system is defined and assigned an address, typically a terminal (handset) ID, and available functions. The functions may be a set of default functions plus a customized set of value added functions as appropriate for the customer. Subsequently, in a stage S2, a user client is defined as necessary and made available for download to cellular telephones intended to be part of the particular telephone system arrangement. Finally, in a stage S3, the telephone system is configured for the specific cellular phones desired to be included. In stage S3, the cellular telephones may be grouped as a single set of telephones, each with the same accessibility to telephone system functions. More usually, however, the telephones are grouped in this stage into two or more sub-groups, each sub-group having different levels of accessibility to functions. Thus, for example, only one or two master telephones would usually be set to support reprogramming of the telephone system, whereas all telephones may be set to support dialing using short or extension numbers and provide call pickup, call forwarding and like functions.

It will be appreciated by the skilled person that the order of the three stages in FIG. 5 may be changed, since none of the stages is dependent on completion of either of the others.

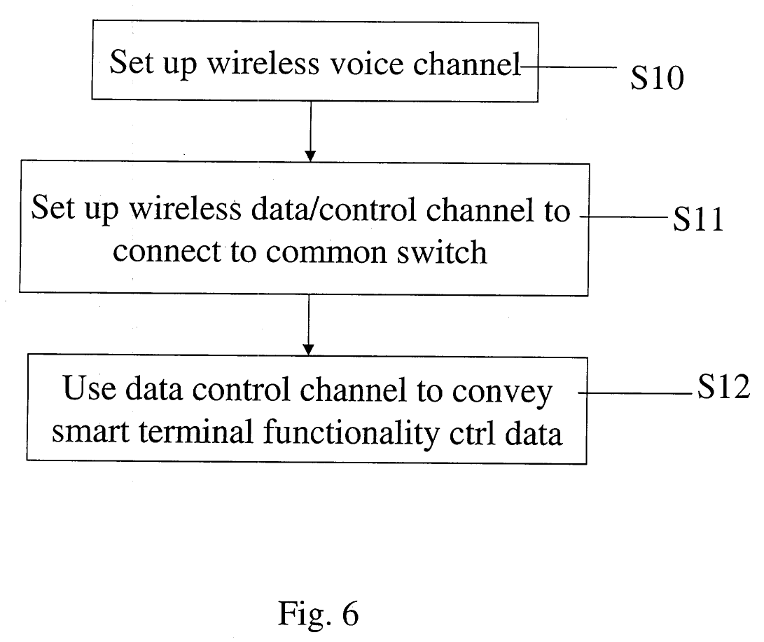

Reference is now made to FIG. 6, which is a simplified diagram showing how a call that supports smart handset functionality may be set up between a cellular telephone and a virtual telephone system of the kind set up in FIG. 5. In a stage S10, a voice line is set up between the Centrex software 24 and the cellular telephone. In a stage S11, a data connection is set up between the Centrex software 24 and the cellular telephone. The voice and data connections are both provided by standard cellular connections. Then, in a stage S12, as a smart handset function is selected, the data connection is used to transfer the accompanying data between the MSC and the cellular telephone. At the cellular telephone, the accompanying data is acted upon by the client software installed therein, following stage S2 of FIG. 5.

Thus, the cellular telephone becomes enabled as a smart handset for use with a virtual office telephone system. It is noted that the Centrex software of the present invention can also support conventional telephones in that the conventional telephones can be configured as belonging to given groups. However, the conventional telephones can only provide so-called dumb terminals as they do not have either a data link or the possibility of running client software.

It is noted that the mobile telephones are able to make calls other than using the Centrex Software, and, in such a case the Centrex software obtains the status (on-hook/off-hook, etc.) of the mobile telephone from the MSC. In general, calls are routed via the Centrex. Centrex software comprises a set of telephone numbers allocated for each Centrex group, and calls to these numbers are routed to the Centrex software via the MSC for subsequent distribution to the various mobile telephones

In the following claims, the term “wireless” includes both the mobile telephony environment and the wireless local loop environment.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations et the various features described hereinabove as well as variations and modifications thereof which would occur to persons skilled in the art upon reading the foregoing description.

What is claimed is:

1. A remote telephone system for wireless telephony devices, the system comprising:
a remote server comprising a communication control support to provide digital communication function control for respective wireless telephony devices arranged in a plurality of groups, and
a data port operatively connected to said communication control support which supports wireless data links to the respective wireless telephony devices, wherein said wireless data link is usable by said remote server to exchange said digital communication function control with a respective wireless telephony device of one of said groups.

2. The remote telephone system according to claim 1, wherein said communication control support comprises a user input for receiving user input data from a respective wireless telephony device via said data port and a configuration unit for using said input data to configure said communication control support for said respective wireless telephony device.

3. The remote telephone system according to claim 1, wherein said remote server is a Centrex server.

4. The remote telephone system according to claim 1, wherein said communication control support includes at least one of a group of functions comprising: selection of a telephone number from a displayed list, selection of a telephone number from a displayed list of names, call forward, visual activation of call forward, visual deactivation of call forward, visual display of call forward activation, call follow me, visual activation of call follow me, visual deactivation of call follow me, visual display of call follow me activation, call pickup, hot line, telephone conferencing, redial, internal CLI, CCBS, visual voicemail notification, display of waiting voicemails, and pin based telephone locking.

5. The remote telephone system according to claim 1, further comprising a display capability support operable to configure said digital communication function control to provide visual information display at said wireless telephony devices.

6. The remote telephone system according to claim 1, wherein said communication control support comprises a group definition unit to define groups of wireless telephony devices to be treated as a group by predefined functions of said digital communication function control.

7. The remote telephone system according to claim 6, wherein said predefined functions include internal CLI.

8. The remote telephone system according to claim 6, wherein said group definition unit is further operable to define subgroups of said defined groups, said subgroup in turn to be treated as a group by further predefined functions of said digital communication function control.

9. The remote telephone system according to claim 8, wherein said further predefined functions comprise call pickup.

10. The remote telephone system according to claim 1, wherein said communication control support is compatible with a handset user client installable on said wireless telephony devices.

11. The remote telephone system according to claim 10, wherein said handset user client is a binary runtime environment for wireless (BREW) compatible client.

12. The remote telephone system according to claim 10, wherein said handset user client is a Java compatible client.

13. The remote telephone system according to claim 10, wherein said handset user client is a downloadable client.

14. The remote telephone system according to claim 1, further comprising a download unit for downloading a user client to a wireless telephony device to support said digital communication function control.

15. The remote telephone system according to claim 1, wherein said communication control support includes a plurality of functions, the plurality of functions being separately defined for different groups.

16. A wireless voice communication end unit comprising:
a wireless voice communication mechanism,
a wireless data communication mechanism, and
a software client which operatively associates said wireless data communication mechanism with said wireless voice communication mechanism, thereby configuring remotely supported communication control features supplied from a remote communication control unit via said data communication mechanism for said end unit.

17. The wireless voice communication end unit according to claim 16, further comprising a user input operable to receive user supplied configuration data for sending to said remote communication control unit.

18. The wireless voice communication end unit according to claim 16, wherein said remote communication control unit is a Centrex server, said remote communication control unit comprising Centrex local support.

19. The wireless voice communication end unit according to claim 16, wherein said communication control features include at least one of a group of functions comprising: selection of a telephone number from a displayed list, selection of a telephone number from a displayed list of names, call forward, visual activation of call forward, visual deactivation of call forward, visual display of call forward activation, call follow me, visual activation of call follow me, visual deactivation of call follow me, visual display of call follow me activation, call pickup, hot line, telephone conferencing, redial, internal CLI, CCBS, visual voicemail notification, display of waiting voicemails, and pin based telephone locking.

20. The wireless voice communication end unit according to claim 16, further comprising visual information display support for said communication control features.

21. The wireless voice communication end unit according to claim 16, comprising a programmable group definition mechanism to define said end unit as part of a group of end units for predetermined ones of said communication control features.

22. The wireless voice communication end unit according to claim 21, wherein said predetermined ones of said communication control features include at least one of internal CLI and call pickup.

23. The wireless voice communication end unit according to claim 21, wherein said programmable group definition mechanism is further operable to define said end unit as part of a subgroup within said group for at least one further predetermined function.

24. The wireless voice communication end unit according to claim 23, wherein said at least one further predetermined function comprises call pickup.

25. The wireless voice communication end unit according to claim 16, further comprising a binary runtime environment for wireless (BREW) operating environment operable to support said client.

26. The wireless voice communication end unit according to claim 16, further comprising a binary runtime environment for wireless WIPI operating environment operable to support said client.

27. The wireless voice communication end unit according to claim 16, comprising a Java operating environment operable to support said client.

28. The wireless voice communication end unit according to claim 16, comprising a Symbian compatible operating environment operable to support said client.

29. A wireless end unit smart terminal client for a wireless end unit comprising:
a voice communication mechanism operable to set up and maintain a voice communication channel;
a data communication mechanism operable to set up and maintain a data communication channel; and
a co-ordinator operable to associate said voice communication mechanism and said data communication mechanism to utilize received data to control said voice communication mechanism, said coordinator further being operable to configure said control for groupwise co-operation with other wireless end units.

30. A method of remotely providing smart handset functionality comprising:
setting up a telephone system support unit at a mobile switching center location,
downloading a smart handset client to wireless end units, said smart handset client being operable to manage a voice communication channel and a data communication channel to said telephone system support unit, and
defining groups of wireless end units for joint switching.

31. A method of remotely providing smart switching functionality to a wireless end unit, the method comprising:
setting up a wireless voice connection channel,
setting up a wireless data connection channel in operative association with said wireless voice connection channel and directed at a remotely located common switching unit, and
using said wireless data channel to convey configuration data between said wireless end unit and said remotely located common switching unit, said configuration data being for providing smart switching functionality to said wireless end unit.
